(19) United States
(12) Patent Application Publication
(10) Pub. No.: US 2017/0118928 A1
(43) Pub. Date: May 4, 2017

(54) Subsurface Water, Air and/or Nutrient Delivery Tube

(71) Applicant: Wow Product Sales, LLC, Fenton, MI (US)

(72) Inventor: David M. Allen, Howell, MI (US)

(21) Appl. No.: 15/339,878

(22) Filed: Oct. 31, 2016

Related U.S. Application Data
(60) Provisional application No. 62/249,191, filed on Oct. 31, 2015.

(51) Int. Cl. A01G 25/06

(52) U.S. Cl. CPC A01G 25/06

(57) ABSTRACT

A subsurface water, air and/or nutrient delivery tube having an upper cap portion and a depending elongated tubular portion depending therefrom. The upper cap portion includes a central portion having openings therethrough. The depending elongated tubular portion is frustoconical in configuration and includes a plurality of holes extending therethrough, between an upper and lower end thereof. In some configurations, multiple delivery tubes can be coupled together one of end to end and nested.

### CROSS-REFERENCE TO RELATED APPLICATION

This application claims priority from U.S. Pat. App. Ser. No. 62/249,191, filed Oct. 31, 2015, entitled Subsurface Water, Air and/or Nutrient Delivery Tube, the entire specification of which is hereby incorporated by reference in its entirety.

### BACKGROUND OF THE DISCLOSURE

1. Field of the Disclosure

The invention relates in general to watering devices and systems for irrigation, feeding and aeration of roots of plants, such as trees, bushes and shrubs, and more particularly, to a subsurface water, air and/or nutrient delivery tube.

2. Background Art

The use of nutrient delivery systems is known in the art. It is known that, due to compacted soil and similar conditions, absorbing oxygen, water and nutrients by a plant is difficult in urban environments. With such inhibited absorption, plants become more susceptible to disease and damage due to insects and the like.

Problematically, it is often difficult to economically form delivery tubes which can direct such nutrients, air and/or water to the root of a plant or the like. Many existing structures are rather expensive to form and to manufacture, while others have features that limit applicability in varying environments.

### SUMMARY OF THE DISCLOSURE

The disclosure is directed to a subsurface water, air and/or nutrient delivery tube. The delivery tube includes an upper cap portion and a depending elongated tubular portion. In addition, the delivery tube can be nested or attached end to end to form a longer member from multiple tubs. In addition, the configuration is well suited for injection molding.

In an aspect of the disclosure, the disclosure is directed to a subsurface water, air and/or nutrient delivery tube comprising an upper cap portion and a depending elongated tubular portion. The upper cap portion has at least one opening therethrough. The depending elongated tubular portion depends from the upper cap portion. The depending elongated tubular portion including an inner surface and an outer surface. The elongated tubular portion includes a plurality of openings extending therethrough. The delivery tube is structurally configured to have the depending elongated tubular portion at least partially buried within the ground. The upper cap portion configured to receive water, air and/or nutrients passable through the at least one opening in the upper cap portion.

In some configurations, the depending elongated tubular portion comprises a frustoconical configuration.

In some configurations, the frustoconical configuration comprises a right frustoconical configuration.

In some configurations, the depending elongated tubular portion further comprises a plurality of longitudinal ribs that extend between the first and second ends with a transverse hoop with the interaction therebetween forming the openings of the depending elongated tubular portion.

In some configurations, the longitudinal ribs form the inner structure and the transverse hoop defines the outer structure.

In some configurations, the longitudinal ribs are spaced apart from each other at both the first and second ends.

In some configurations, the shape of the longitudinal ribs and the transverse hoop are substantially identical.

In some configurations, the transverse hoop comprises a single hoop that helically winds about the longitudinal ribs.

In some configurations, the upper cap portion includes an outer rim that extends outwardly beyond the depending elongated tubular portion at an upper end thereof.

In some configurations, at least a portion of the upper cap portion is outwardly convex.

In some configurations, the outwardly convex of the upper cap portion includes a plurality of openings extending therethrough.

In some configurations, the depending elongated tubular portion includes a side opening structurally configured to receive an irrigation tube.

In some configurations, the subsurface delivery tube further comprises a lower flange, including an upper surface and a lower surface opposite the upper surface.

In some configurations, the subsurface delivery tube comprises a monolithic single piece injection molded member.

In some configurations, the depending elongated tubular portion further includes a stepped portion positioned between the first and second end thereof. A portion of the depending elongated tubular portion below the stepped portion being radially outward of a portion of the depending elongated tubular portion above the stepped portion.

In some configurations, the stepped portion further includes a lower surface seat. The lower surface seat is structurally configured to receive an upper cap portion of a second subsurface delivery tube.

In some configurations, the stepped portion is substantially parallel to the upper cap portion.

In some configurations, the upper portion and the lower portion each comprise frustoconical configurations.

In some configurations, the depending elongated tubular portion has a length of between approximately 6 and 12 inches.

### BRIEF DESCRIPTION OF THE DRAWINGS

The disclosure will now be described with reference to the drawings wherein:

FIG. 1 of the drawings is a perspective view of the subsurface water, air and nutrient delivery tube of the present disclosure;

FIG. 2 of the drawings is a side elevational view thereof;

FIG. 3 of the drawings is a side cross-sectional view thereof;

FIG. 4 of the drawings is a perspective cross-sectional view thereof;

FIG. 5 of the drawings is a top cross-sectional view thereof;

FIG. 6 of the drawings is an alternate configuration showing a lower flange;

FIG. 7 of the drawing is an alternate configuration showing, in particular, the nesting of multiple delivery tubes; and

FIG. 8 of the drawings is an alternate configuration showing, in particular, the side opening in the depending elongated tubular portion for an irrigation tubing.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

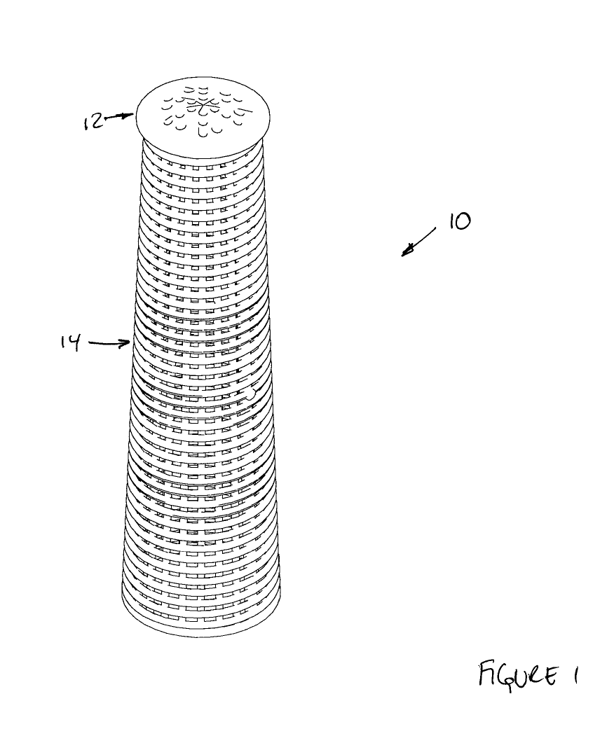

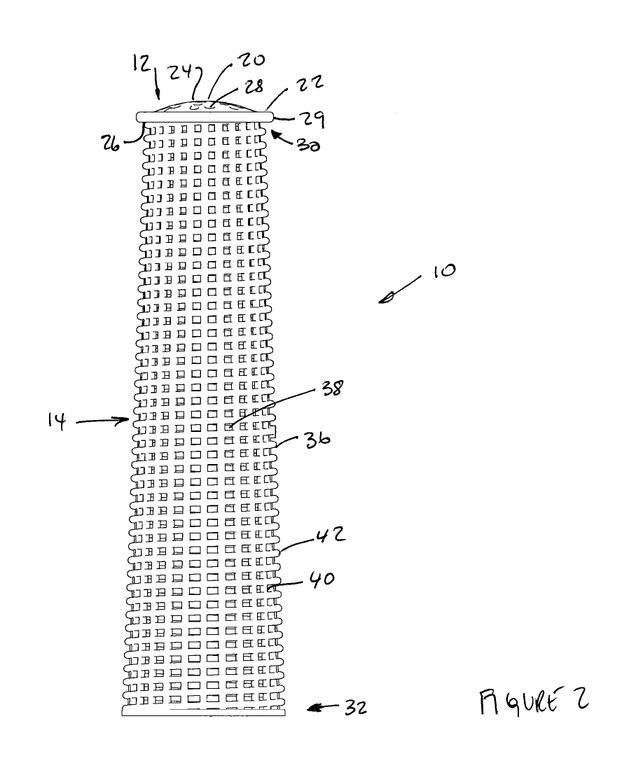

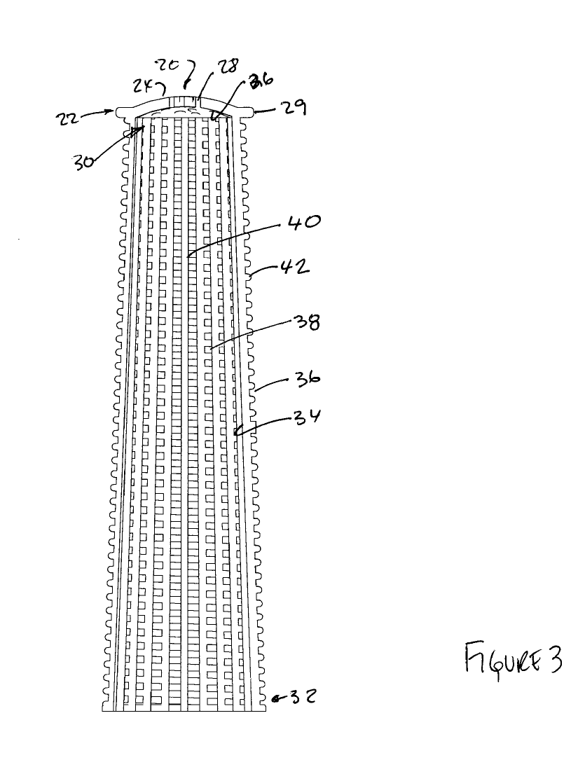

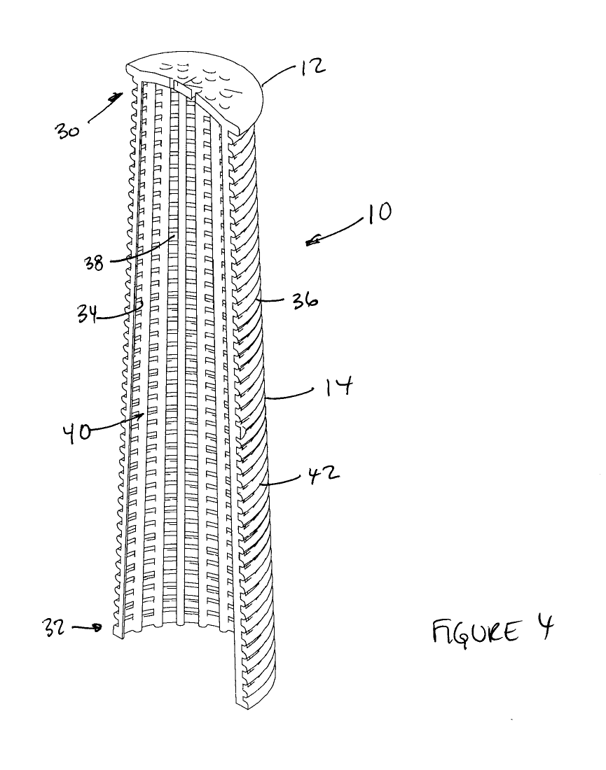

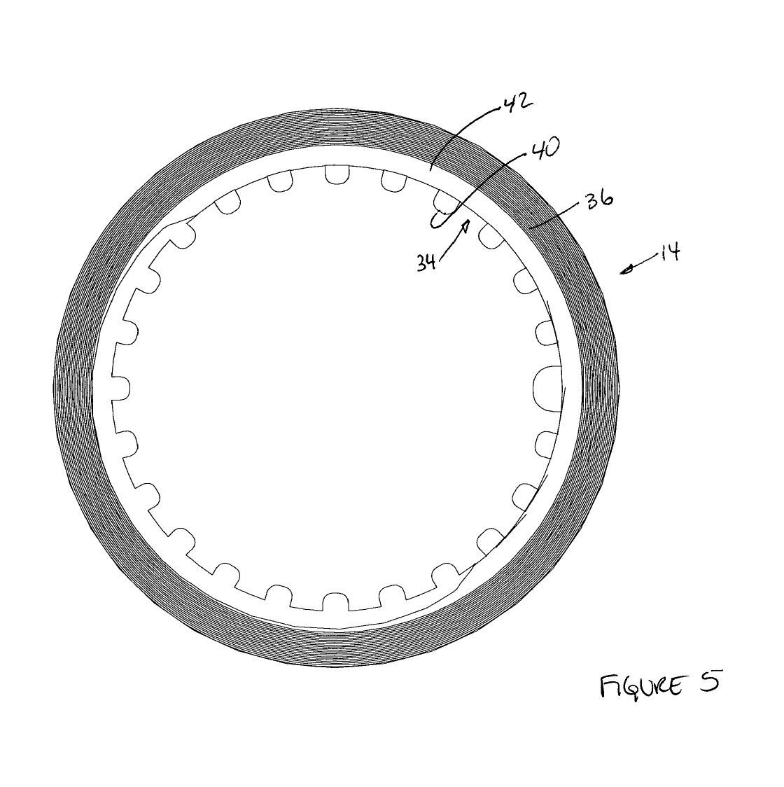

Referring now to the drawings and in particular to FIGS. 1 through 5, the subsurface water, air and/or nutrient delivery tube (hereinafter, sometimes, subsurface delivery tube) is shown generally at 10. The tube is configured to be positioned into the ground so as to provide a passageway for such materials (i.e., any one or all of water, air and/or nutrients, among other things) to be directed into the soil, and, desirably to the roots of a plant, tree, shrub or other landscape feature. It will be understood that various of other delivery systems may be incorporated, such as irrigation drip emitters and the like. It will be understood that the configuration is not limited to any particular size or shape, however, it is contemplated that the subsurface delivery tube may be of, for example 6 inches to 12 inches in length, the former corresponding for shrubs and garden use, with the larger corresponding for use in association with larger trees and the like. Of course, these sizes are solely for illustrative purposes, and it is contemplated that both smaller and larger sizes are contemplated for use, as are sizes in between those sizes identified.

The subsurface delivery tube includes upper cap portion 12 and depending elongated tubular portion 14. Preferably the upper cap portion and the depending elongated tubular portion comprise an integrally molded polymer based member that comprises a monolithic single piece injection molded member. Such a configuration allows for molding through techniques known to those of skill in the injection molding arts.

The upper cap portion 12 includes central portion 20 and outer flange 22. The upper cap portion, in the configuration shown includes a substantially circular outer configuration terminating with outer rim 29. The upper cap portion is generally symmetrical about the center of the substantially circular member. The central portion 20 is outwardly convex, and, in the configuration shown, dome like, with the peak of the configuration corresponding to the center thereof. The outer flange 22 is substantially planar, while the thickness of each of the central portion and the outer flange being substantially uniform (although not required to be as such), while the outer rim can be rounded for purposes of limiting sharp edges and the like (while it is contemplated that the outer flange may have other configurations, or may be eliminated. In other configurations, the central portion may be substantially planar or may include various surface variations and the like. In still other configurations, the central portion may be outwardly concave or may be outwardly both convex in portions and concave in portions.

A plurality of openings 28 are disposed through the central portion 20 of the upper cap portion. In the configuration, a plurality of axially outward openings are spaced apart from each other, with each comprising three openings which are collinear. A larger opening is positioned between each set of axial openings proximate the outer end thereof. Of course, in other configurations, the position, size, quantity, shape and other features thereof may be varied.

The depending elongated tubular portion 14 is shown in FIGS. 1 through 5 as extending from upper end 30 to lower end 32. In the configuration shown, the elongated tubular portion comprises a right frustoconical configuration that is substantially uniform between the upper end and the lower end, wherein the cross-sectional configuration changes uniformly between the two ends. In other configurations, an oblique frustoconical configuration is contemplated, as well as other offset configurations, whereas in the configuration shown, the shape is generally symmetrical about an axis that is perpendicular to the upper cap portion and co-axial with the center axis of the upper cap portion.

The depending elongated tubular portion 14 is further defined by the inner surface 34 and the outer surface 36 which are on opposing sides of each other, and which include a plurality of holes, such as hole 38 extending therethrough. In the configuration shown, the holes 38 are substantially uniformly substantially rectangular openings disposed on a generally conical outer surface. The holes are sized so as to allow for the passage of material therethrough, while also sized to receive irrigation drip emitters therethrough. It is contemplated that the holes may have different configurations, that they may not be uniformly disposed along the surface thereof, and that they may have differing spacing. The holes in the present configuration are for illustrative purposes.

In the configuration shown, the depending elongated tubular portion 14 is formed by a cooperation between a plurality of longitudinal ribs, such as rib 40 and a transverse hoop 42. The longitudinal ribs extend between the first and second ends, and are generally substantially vertically oriented, so as to be in a plane that is substantially perpendicular to the upper cap portion. The longitudinal ribs are spaced apart from each other at both the first and second ends, with the spacing being maintained so that it is proportional at both ends.

The transverse hoop 42 extends about the outside of the longitudinal ribs. In the configuration, the transverse hoop 42 comprises a single hoop that helically winds about the vertical ribs from the first end to the second end. In the configuration shown, the transverse hoop 42 has a shape that is much like the vertical ribs so that dimensionally, the two are quite similar. In other configurations, the transverse hoop may comprise a plurality of hoops that either wind directly around (defining a set of substantially parallel hoop-like configurations, or a transverse hoop that includes a plurality of windings).

Thus, the depending elongated tubular portion is defined by a two layer configuration of the longitudinal ribs forming the inner structure or layer and the transverse hoop forming the outer structure or layer. It will be understood that such a configuration allows for the formation of the holes 40 and also fosters the formation thereof in injection molding equipment.

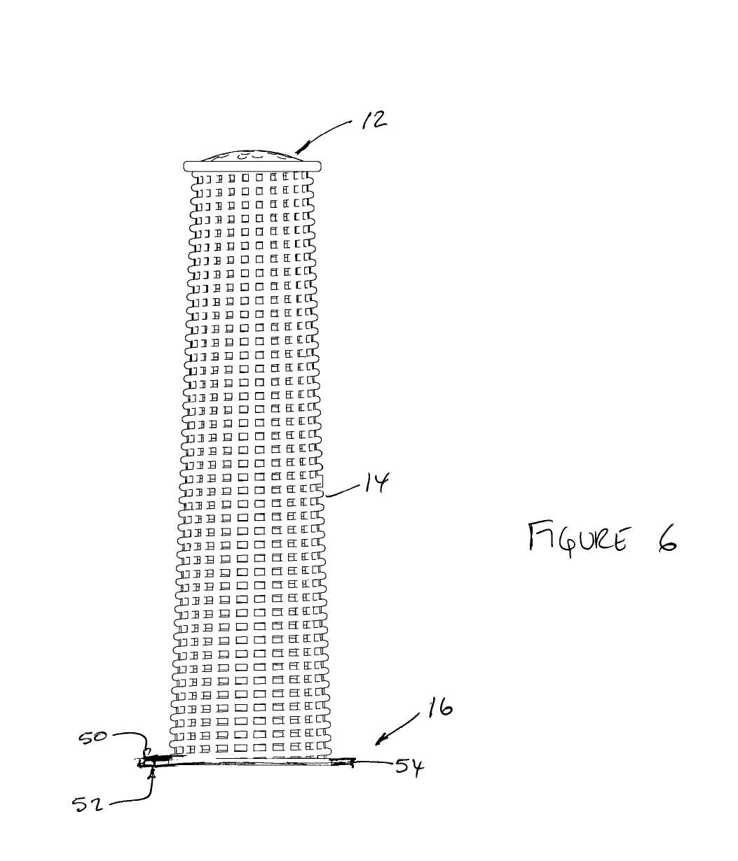

In some configurations, such as the configuration of FIG. 6, a lower flange, such as lower flange 16 may be provided at or near the second end of the depending elongated tubular portion. The lower flange 16 includes upper surface 50, lower surface 52 and outer rim 54. The lower flange further provides stabilization of the delivery tube when in the ground, precluding removal thereof, or upward unearthing.

In another configuration, it is contemplated that for some installations, it may be desirable to have elongated or longer delivery tubes. For example, where the length of the deliver tube is 12 inches, there may be situations wherein a larger or longer deliver tube would be preferred. To accommodate different lengths, it is contemplated that the deliver tubes can be nested end to end, or attachable end to end.

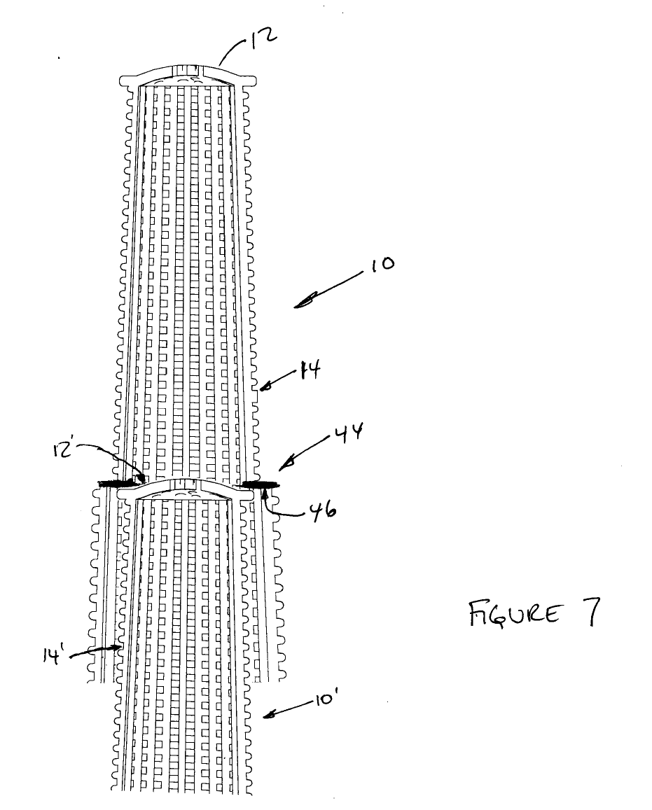

One such configuration is shown in FIG. 7 as comprising stepped portion 44 which defines lower surface seat 46. The stepped portion essentially divides the depending elongated tubular portion into an upper and a lower frustoconical configuration, with the lower surface seat 46 spanning from the lower end of the upper frustoconical configuration to the upper end of the lower frustoconical configuration. Essentially, it is contemplated that the upper end of the lower frustoconical configuration essentially match the shape of the outer rim 29 of the upper cap portion 12 closely so that the upper end of a second delivery tube can be inserted into the lower end of the first delivery tube. The insertion would continue until the upper surface 24 of the upper cap portion of the second delivery tube abutted the lower surface seat 46, while at the same time, the depending elongated tubular portion proximate the lower surface seat can engage and retain the outer rim 29 of the upper cap portion. Detents or other structures which allow for engagement, while discouraging and/or precluding disengagement are contemplated. Such one way locking flanges may be positioned below the lower surface seat corresponding in position to the thickness of the outer flange of the upper cap portion of the second delivery tube.

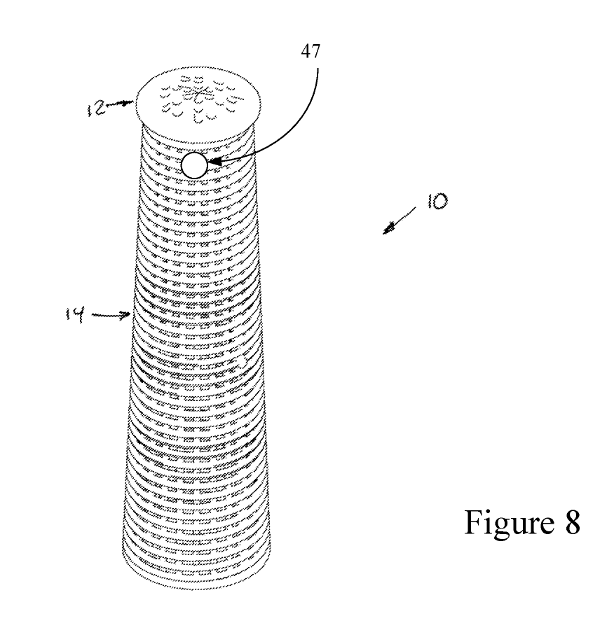

In another configuration, shown in FIG. 8, the depending elongated tubular portion 14 may include a side opening, such as side opening 47 which is sized and configured to receive irrigation tubing therethrough so as to permit the passage into the central cavity of the delivery tube. In the configuration shown, the side opening 47 is positioned proximate the upper end 30 of the depending elongated tubular portion.

In operation, the user can dig or poke into the ground to define a bore into the ground that is sized so as to receive the subsurface delivery tube. Once formed, the subsurface delivery tube can be directed and positioned within the bore. Preferably, the delivery tube is directed into the ground until the upper cap portion is substantially flush with the surface of the ground. In some configurations, wherein the upper cap portion is convex, the convex shape may extend above the ground. In some configurations, greater depth is required, and in such configurations, multiple subsurface delivery tubes can be stacked together (and in such configurations a stepped portion may be provided to nest the tubes together). In other configurations, a drip tube or the like may be directed through the depending elongated tubular portion so as to provide water, air and/or nutrients into the cavity defined thereby.

As the area is watered through natural means, or automatically or manually through irrigation systems, water, air and/or nutrients can be directed through the openings of the upper cap portion and directed into the ground through the cavity formed by the depending elongated tubular portion. At such time, the same can be directed outwardly through the holes of the depending elongated tubular portion into the surrounding ground. This facilitates the water to pass where needed instead of remaining on the surface of the ground. Any soil or other ground material that are found in the cavity defined by the depending elongated tubular portion generally remains loose and permits the passage of wear therethrough.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A subsurface water, air and/or nutrient delivery tube comprising:
an upper cap portion, having at least one opening therethrough; and
a depending elongated tubular portion depending from the upper cap portion, the depending elongated tubular portion including an inner surface and an outer surface, the elongated tubular portion including a plurality of openings extending therethrough,
wherein the deliver tube is structurally configured to have the depending elongated tubular portion at least partially buried within the ground, with the upper cap portion configured to receive water, air and/or nutrients passable through the at least one opening in the upper cap portion.

2. The subsurface water, air and/or nutrient delivery tube of claim 1 wherein the depending elongated tubular portion comprises a frustoconical configuration.

3. The subsurface water, air and/or nutrient delivery tube of claim 2 wherein the frustoconical configuration comprises a right frustoconical configuration.

4. The subsurface water, air and/or nutrient delivery tube of claim 1 wherein the depending elongated tubular portion further comprises a plurality of longitudinal ribs that extend between the first and second ends, with a transverse hoop with the interaction therebetween forming the openings of the depending elongated tubular portion.

5. The subsurface water, air and/or nutrient delivery tube of claim 4 wherein the longitudinal ribs forming an inner structure and the transverse hoop defines an outer structure.

6. The subsurface water, air and/or nutrient delivery tube of claim 5 wherein the longitudinal ribs are spaced apart from each other at both the first and second ends.

7. The subsurface water, air and/or nutrient delivery tube of claim 6 wherein the shape of the longitudinal ribs and the transverse hoop are substantially identical.

8. The subsurface water, air and/or nutrient delivery tube of claim 3 wherein the transverse hoop comprises a single hoop that helically winds about the longitudinal ribs.

9. The subsurface water, air and/or nutrient delivery tube of claim 1 wherein the upper cap portion includes an outer rim that extends outwardly beyond the depending elongated tubular portion at an upper end thereof.

10. The subsurface water, air and/or nutrient delivery tube of claim 9 wherein at least a portion of the upper cap portion is outwardly convex.

11. The subsurface water, air and/or nutrient delivery tube of claim 10 wherein the outwardly convex of the upper cap portion includes a plurality of openings extending therethrough.

12. The subsurface water, air and/or nutrient delivery tube of claim 1 wherein the depending elongated tubular portion includes a side opening structurally configured to receive an irrigation tube.

13. The subsurface water, air and/or nutrient delivery tube of claim 1 further comprising a lower flange, including an upper surface and a lower surface opposite the upper surface.

14. The subsurface water, air and/or nutrient delivery tube of claim 1 wherein the subsurface delivery tube comprises a monolithic single piece injection molded member.

15. The subsurface water, air and/or nutrient delivery tube of claim 1 wherein the depending elongated tubular portion further includes a stepped portion positioned between the first and second end thereof, with a portion of the depending elongated tubular portion below the stepped portion being radially outward of a portion of the depending elongated tubular portion above the stepped portion.

16. The subsurface water, air and/or nutrient delivery tube of claim 15 wherein the stepped portion further includes a lower surface seat, the lower surface seat structurally configured to receive an upper cap portion of a second subsurface delivery tube.

17. The subsurface water, air and/or nutrient delivery tube of claim 16 wherein the stepped portion is substantially parallel to the upper cap portion.

18. The subsurface water, air and/or nutrient delivery tube of claim 15 wherein the upper portion and the lower portion each comprise frustoconical configurations.

19. The subsurface water, air and/or nutrient delivery tube of claim 1 wherein the depending elongated tubular portion has a length of between approximately 6 and 12 inches.
